(19) United States
(12) Patent Application Publication
(10) Pub. No.: US 2026/0352967 A1
(43) Pub. Date: Nov. 5, 2026

(54) INFORMATION PROCESSING DEVICE

(71) Applicant: Sony Semiconductor Solutions Corporation, Kanagawa (JP)

(72) Inventor: Yuki Machino, Kanagawa (JP)

(21) Appl. No.: 19/124,700

(22) PCT Filed: Oct. 31, 2023
(86) PCT No.: PCT/JP2023/039183

§ 371 Date: Apr. 25, 2025

(30) Foreign Application Priority Data
Nov. 11, 2022 (JP) 2022-181414

(51) Int. Cl. H04N 25/47; G06N 3/082; G06T 7/11

(52) U.S. Cl. CPC H04N 25/47; G06N 3/082; G06T 7/11

(57) ABSTRACT

Visualization of the occurrence time and frequency of an event in a human-understandable form is disclosed. In one example, an information processing device includes a pixel with a light detection element that detects an event based on an amount of change in a light amount of incident light, and a pixel data generation unit that generates pixel data including information regarding the event detected in each of a plurality of unit periods.

### TECHNICAL FIELD

The present disclosure relates to an information processing device.

### BACKGROUND ART

A proposed event-based vision sensor (EVS) that quickly acquires event information from a photoelectric conversion element when any event, such as a change in luminance, occurs in an imaging scene. This EVS detects, as an event, a change in luminance caused by, for example, the movement of a subject.

A known method visualizes a detected event in a human-understandable form by converting the event into an image on a frame-by-frame basis. In frame-based visualization, a frame image including events that have occurred within a specific period, known as a time slice, is generated. When the time slice is long, a captured frame image becomes easier for humans to understand, but event information regarding an event that has occurred a plurality of times at the same pixel is compressed, and the advantage of EVS's high-speed performance is compromised. Conversely, when the time slice is short, the advantage of high-speed performance can be utilized, but a captured frame image becomes difficult for humans to understand. Therefore, a method has been proposed to overlap time slices to generate frame images that enhance visibility while maintaining EVS's high-speed performance. (see, for example, Non-Patent Document 1).

### CITATION LIST

### Patent Document

Non-Patent Document 1: XIE, Xuemei, et al. An improved approach for visualizing dynamic vision sensor and its video denoising. In: Proceedings of the International Conference on Video and Image Processing. 2017. p. 176-180.

### SUMMARY OF THE INVENTION

### Problems to be Solved by the Invention

However, in the method disclosed in Non-Patent Document 1, the occurrence time and occurrence frequency of each event in the frame image cannot be grasped. Therefore, it is not possible to determine which is new and which is old among a plurality of events. Furthermore, it is not possible to determine whether or not an event frequently occurs at the same pixel position within the time slice.

The present technology has been made in view of such circumstances, and it is therefore an object of the present technology to provide an information processing device that enables visualization of the occurrence time and occurrence frequency of an event in a human-understandable form.

### Solutions to Problems

In order to solve the above-described problems, the present disclosure provides is an information processing device including:
a pixel including a light detection element that detects an event based on an amount of change in a light amount of incident light; and
a pixel data generation unit that generates pixel data including information regarding the event detected in each of a plurality of unit periods.

The pixel data may have a pixel value corresponding to a detection time and detection frequency of the event.

The pixel data may have a larger pixel value as the detection time of the event is more recent and the detection frequency of the event is higher.

The pixel data may have a grayscale level or luminance corresponding to the number of the plurality of unit periods.

The pixel data may include bit-string data of a plurality of bits, and
the information regarding the event in older unit periods may be arranged from a higher-order bit side to a lower-order bit side of the bit-string data.

The information regarding the event may be represented by one or more bits for each of the unit periods.

The pixel data may include information indicating a polarity of the event for each of the unit periods.

The plurality of unit periods may have an identical time width.

Of the plurality of unit periods, an older unit period may have a longer time width.

A plurality of the pixels arranged in a one-dimensional array or a two-dimensional matrix;
a frame generation unit that generates frame data including the information regarding the event occurred within a predetermined period on a frame-by-frame basis, each frame including the plurality of pixels; and
a split frame generation unit that generates a plurality of pieces of split frame data by splitting the frame data into a plurality of pieces along a time axis may be further included, in which
the pixel data generation unit may generate the pixel data for each of the plurality of pixels on the basis of the information regarding the event of a corresponding pixel included in each of the plurality of pieces of split frame data.

Two pieces of the frame data adjacent to each other along the time axis may include the information regarding the event occurred within an overlapping time range.

The overlapping time range may have a length that is an integral multiple of each of the unit periods.

The pixel data generation unit may associate each bit of the pixel data with a corresponding one of the pieces of split frame data different from each other, and generate a corresponding bit value of the pixel data on the basis of the information regarding the event of a corresponding pixel in a corresponding piece of the split frame data.

The pixel data generation unit may generate a bit value of a higher-order bit of the pixel data on the basis of the information regarding the event a corresponding pixel in a more recent piece of the split frame data.

The split frame generation unit may split the frame data into the plurality of pieces of split frame data of the unit periods having an identical time length.

The split frame generation unit may split the frame data into the plurality of pieces of split frame data of the unit periods having different time lengths.

The split frame generation unit may make the time length of a more recent piece of the split frame data shorter.

A frame image generation unit that generates a frame image on the basis of the plurality pieces of pixel data corresponding to the plurality of pixels may be further included.

The frame image generation unit may generate the frame image such that two of the frame images, having a grayscale corresponding to a detection time and detection frequency of the event for each of the pixels and adjacent to each other along the time axis, include the information regarding the event within an overlapping time range.

A learning unit that performs learning processing of updating a weight of a neural network used for predetermined information processing, the predetermined information processing including at least one of object tracking, object recognition, or prediction of object motion, on the basis of the frame image; and an information processing unit that performs the predetermined information processing on the basis of the neural network that has undergone the learning processing and the frame image may be further included.

### BRIEF DESCRIPTION OF DRAWINGS

FIG. 1 is a block diagram illustrating a configuration example of an information processing device according to a first embodiment of the present disclosure.

FIG. 2 is a block diagram illustrating a configuration example of a sensor.

FIG. 3A is a circuit diagram illustrating a first example of a pixel.

FIG. 3B is a circuit diagram illustrating a second example of the pixel.

FIG. 4A is a diagram illustrating a first example of a stacked structure of the sensor.

FIG. 4B is a diagram illustrating a second example of the stacked structure of the sensor.

FIG. 5 is a flowchart of event visualization in the information processing device.

FIG. 6 is a diagram for describing frame generation processing.

FIG. 7A is a diagram illustrating image generation processing according to a comparative example.

FIG. 7B is a diagram illustrating image generation processing according to the present disclosure.

FIG. 8 is a block diagram illustrating a detailed configuration of an image generation unit according to the first embodiment of the present disclosure.

FIG. 9 is a flowchart of image generation according to the first embodiment of the present disclosure.

FIG. 10 is a schematic diagram illustrating how frame data is split according to the first embodiment of the present disclosure.

FIG. 11 is a diagram illustrating how pixel data is generated.

FIG. 12 is a diagram illustrating a correspondence between frame data and pixel data according to the first embodiment of the present disclosure.

FIG. 13 is a diagram illustrating how image data is output according to the first embodiment of the present disclosure.

FIG. 14 is a diagram illustrating two pieces of pixel data generated on the basis of two pieces of frame data adjacent to each other along the time axis.

FIG. 15 is a schematic diagram illustrating how frame data is split according to a second embodiment of the present disclosure.

FIG. 16 is a diagram illustrating a correspondence between frame data and pixel data according to the second embodiment of the present disclosure.

FIG. 17 is a block diagram illustrating a detailed configuration of an image generation unit according to a third embodiment of the present disclosure.

FIG. 18 is a flowchart of image generation according to the third embodiment of the present disclosure.

FIG. 19 is a block diagram illustrating a configuration example of an information processing device according to a fourth embodiment of the present disclosure.

FIG. 20 is a schematic diagram illustrating an example of information processing performed by an information processing unit.

FIG. 21 is a block diagram illustrating an example of a schematic configuration of a vehicle control system.

FIG. 22 is an explanatory diagram illustrating an example of installation positions of an outside-vehicle information detecting section and an imaging section.

### MODE FOR CARRYING OUT THE INVENTION

Hereinafter, embodiments of an information processing device will be described with reference to the drawings. Although main components of the information processing device will be mainly described below, the information processing device may have components or functions that are not illustrated or described. The following description is not intended to exclude components and functions that are not illustrated or described.

### First Embodiment

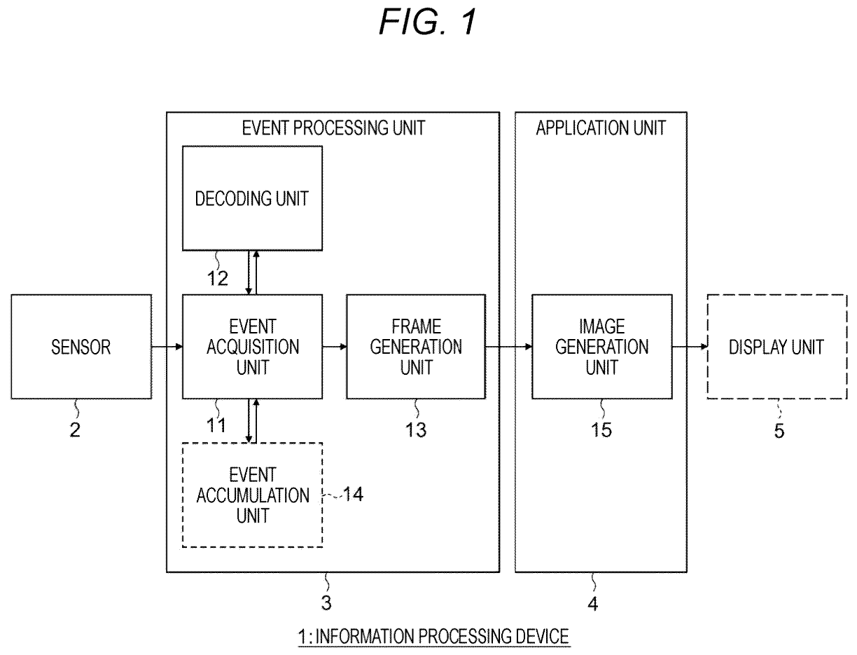

FIG. 1 is a block diagram illustrating a configuration example of an information processing device 1 according to a first embodiment of the present disclosure. The information processing device 1 detects the motion of any specific subject and a change in luminance. The information processing device 1 is applicable to both stationary devices such as an industrial robot and mobile devices such as a smartphone. The information processing device 1 in FIG. 1 includes a sensor 2, an event processing unit 3, and an application unit 4.

The sensor 2 is capable of detecting the movement of a subject and a change in luminance. The sensor 2 is, for example, an event-based vision sensor (EVS). The sensor 2 detects an event based on an amount of change in a light amount of incident light. The event detected by the sensor 2 is provided to the event processing unit 3 via, for example, a mobile industry processor interface (MIPI).

The event processing unit 3 generates frame data including information (hereinafter, referred to as event information) regarding an event occurred within a predetermined period on a frame-by-frame basis, each frame including a plurality of pixels. The event processing unit 3 includes, for example, a field programmable gate array (FPGA). The event processing unit 3 includes an event acquisition unit 11, a decoding unit 12, and a frame generation unit 13.

The event acquisition unit 11 acquires the event information output synchronously or asynchronously from the sensor 2. The event processing unit 3 may temporarily accumulate the event information acquired from the sensor 2 in an event accumulation unit 14.

The decoding unit 12 decodes the event information acquired by the event acquisition unit 11. The event information output from the sensor 2 is compressed data including information such the occurrence time and polarity of the event. The decoding unit 12 decompresses the event information acquired by the event acquisition unit 11 into event data including information such as the occurrence time and polarity of the event. The event data decoded by the decoding unit 12 is provided to the frame generation unit 13.

As described above, the frame generation unit 13 generates frame data including event data generated within the predetermined period. Herein, the predetermined period may be referred to as time slice. The frame generation unit 13 provides the frame data to the application unit 4 via, for example, a universal serial bus (USB).

The application unit 4 includes, for example, an FPGA and generates image data on a frame-by-frame basis. Furthermore, the event processing unit 3 and the application unit 4 may be integrated into a single semiconductor chip. Alternatively, the sensor 2, the event processing unit 3, and the application unit 4 may be integrated into a single semiconductor chip.

The application unit 4 includes an image generation unit 15. The image generation unit 15 generates image data on a frame-by-frame basis on the basis of the frame data provided from the frame generation unit 13. The image data generated by the image generation unit 15 is used, for example, to display a frame image on a display unit 5. Alternatively, the image data generated by the application unit 4 may be used for processing such as object tracking, object recognition, or prediction of object motion as described later.

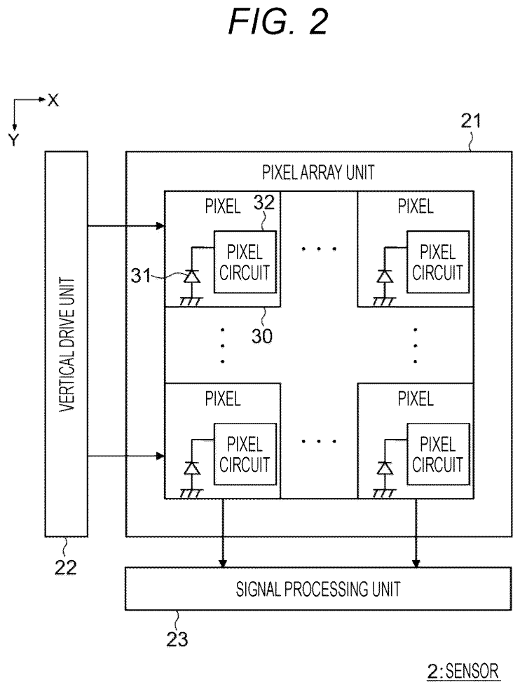

FIG. 2 is a block diagram illustrating a configuration example of the sensor 2. The sensor 2 includes a pixel array unit 21, a vertical drive unit 22, and a signal processing unit 23.

The pixel array unit 21 includes a plurality of pixels 30 arranged in a one-dimensional array or a two-dimensional matrix. Herein, an example where the plurality of pixels 30 is arranged in a two-dimensional matrix will be described. Furthermore, the horizontal direction of FIG. 2 is referred to as row direction X, and the vertical direction is referred to as column direction Y. In FIG. 2, the plurality of pixels 30 is arranged in both the row direction X and the column direction Y.

An event is detected by each of the plurality of pixels 30. Each pixel 30 in FIG. 2 includes a photoelectric conversion element 31 and a pixel circuit 32. The photoelectric conversion element 31 receives light from a subject and generates charges according to the amount of received light. The generated charges are detected as an event by the pixel circuit 32.

The vertical drive unit 22 generates a plurality of vertical drive signals for controlling whether or not to drive a plurality of pixels arranged in the column direction Y. The vertical drive unit 22 can select a pixel block located within any specific range in the column direction Y and sequentially drive the pixels in the selected pixel block.

Furthermore, the sensor 2 may include a horizontal drive unit that controls whether or not to drive a plurality of pixels arranged in the row direction X.

The signal processing unit 23 performs predetermined signal processing on the event detected from each pixel 30. The event that has undergone the signal processing is sequentially output to the downstream event processing unit 3 and the like via an output circuit or the like (not illustrated).

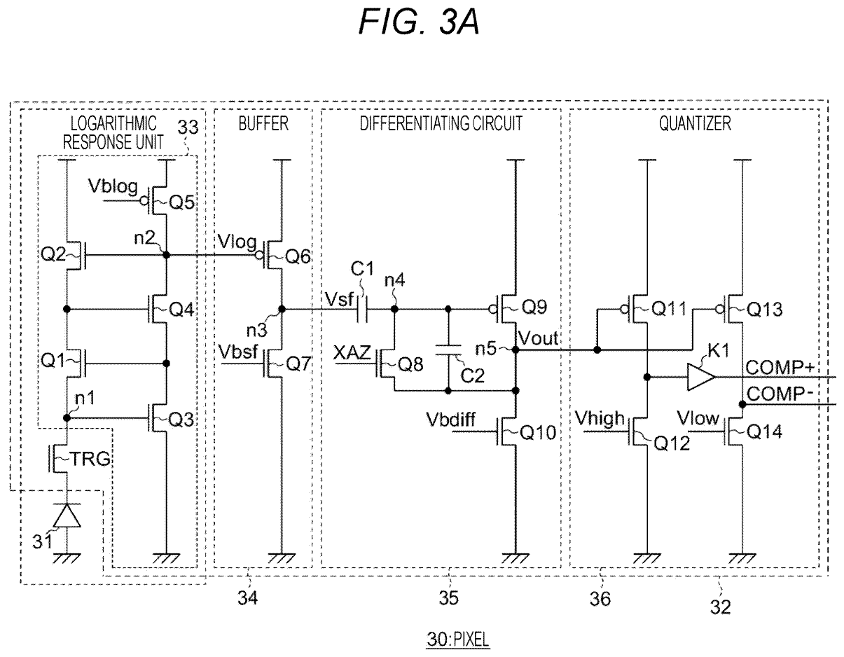

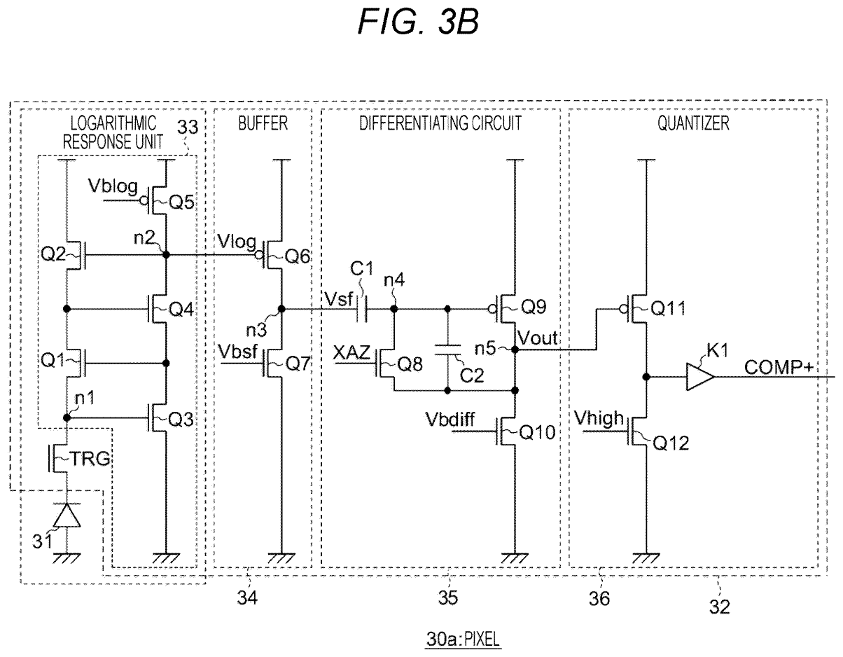

FIG. 3A is a circuit diagram illustrating a first example of each pixel 30. The pixel 30 includes the photoelectric conversion element 31 and the pixel circuit 32. The pixel circuit 32 includes a transfer transistor TRG, a charge-to-voltage conversion unit 33, a buffer 34, a differentiating circuit 35, and a quantizer 36. The charge-to-voltage conversion unit 33, the photoelectric conversion element 31, and the transfer transistor TRG constitute a logarithmic response unit 37.

The logarithmic response unit 37 logarithmically transform the charges resulting from photoelectric conversion in the photoelectric conversion element 31 into a voltage signal Vlog. The reason for the logarithmic transformation is to extend the dynamic range of the pixel 30 that captures luminance information.

The photoelectric conversion element 31 accumulates charges (photocharges) based on incident light incident on the corresponding pixel 30. As the photoelectric conversion element 31, for example, a photodiode is used. The photoelectric conversion element 31 has an anode and a cathode. Either the anode or the cathode (for example, the cathode) is connected to a source of the transfer transistor TRG, and the other (for example, the anode) is connected to a predetermined reference voltage node such as a ground voltage.

The transfer transistor TRG is used to switch the transfer of the photocharges. The transfer transistor TRG is turned on when, for example, a high-level transfer signal is applied to a gate of the transfer transistor TRG. The transfer transistor TRG has its drain connected to an input node n1 of the charge-to-voltage conversion unit 33.

The charge-to-voltage conversion unit 33 converts the photocharges accumulated in the photoelectric conversion element 31 into a voltage. The charge-to-voltage conversion unit 33 includes transistors Q1 to Q5. As the transistors Q1 to Q4, for example, N channel metal-oxide-semiconductor (NMOS) transistors are used. As the transistor Q5, for example, a P channel metal-oxide-semiconductor (PMOS) transistor is used.

The transistors Q1 and Q2 are cascode-connected between a power supply voltage node and the transfer transistor TRG. The transistor Q1 has its source connected to the drain of the transfer transistor TRG and a gate of the transistor Q3. The transistor Q1 has its gate connected to a drain of the transistor Q3 and a source of the transistor Q4. The transistor Q1 has its drain connected to a source of the transistor Q2 and a gate of the transistor Q4. The transistor Q2 has its drain connected to the power supply voltage node. The transistor Q2 has its gate connected to an output node n2 of the charge-to-voltage conversion unit 33, a drain of the transistor Q4, and a drain of the transistor Q5.

The transistor Q3 and the transistor Q4 are cascode-connected between the node n2 and the reference voltage (ground) node. The transistor Q3 has its source connected to the reference voltage (ground) node. The transistor Q4 is arranged between the transistor Q3 and the transistor Q5.

The transistor Q5 has its source connected to the power supply voltage node, and a bias voltage Vblog is applied to a gate of the transistor Q5. The transistor Q5 adjusts a voltage level of the output node n2 on the basis of a voltage level of the bias voltage Vblog.

The voltage signal Vlog resulting from the logarithmic transformation performed by the charge-to-voltage conversion unit 33 is input into the buffer 34. The buffer 34 includes a transistor Q6 and a transistor Q7 cascode-connected between the power supply voltage node and the reference voltage (ground) node. As the transistor Q6, for example, a PMOS transistor is used. As the transistor Q7, for example, an NMOS transistor is used.

The transistor Q6 in the buffer 34 constitutes a source follower circuit. A pixel voltage Vsf based on the voltage signal Vlog output from the charge-to-voltage conversion unit 33 is output from the buffer 34. The voltage signal Vlog is input into a gate of the transistor Q6 from the output node n2 of the charge-to-voltage conversion unit 33. The transistor 06 has its source connected to the power supply voltage node. The transistor 06 has its drain connected to a drain of the transistor Q7 and the differentiating circuit 35 via an output node n3 of the buffer 34.

The transistor Q7 has its source connected to the reference voltage (ground) node. A predetermined bias voltage Vbsf is applied to a gate of the transistor Q7.

The transistor Q7 adjusts a voltage level of the output node n3 on the basis of a voltage level of the bias voltage Vbsf.

The pixel voltage Vsf output from the buffer 34 is input into the differentiating circuit 35. The buffer 34 can enhance the driving capability of the pixel voltage Vsf. Furthermore, the buffer 34 provided as described above can ensure isolation to prevent noise generated when the downstream differentiating circuit 35 performs the switching operation from being transmitted to the charge-to-voltage conversion unit 33.

The differentiating circuit 35 generates a differential signal Vout based on a change in the voltage signal Vlog resulting from the conversion performed by the charge-to-voltage conversion unit 33. The differentiating circuit 35 includes a capacitor C1 and transistors Q8 to Q10. As the transistor Q10, for example, an NMOS transistor is used, and as the transistors Q8 and Q9, for example, PMOS transistors are used.

The capacitor C1 is arranged between a connection node n4 where a source of the transistor Q8 and a gate of the transistor Q9 are connected, and the output node n3 of the buffer 34. The capacitor C1 accumulates charges on the basis of the pixel voltage Vsf provided from the buffer 34. Furthermore, a capacitor C2 is connected between the gate of the transistor Q9 and a drain of the transistor Q10. The capacitor C2 provides charges based on an amount of change in the pixel voltage Vsf resulting from time-differentiating the pixel voltage Vsf to the source of the transistor Q8 and the gate of the transistor Q9.

The transistor Q8 switches whether or not to short-circuit the gate and drain of the transistor Q9 in accordance with an auto-zero signal XAZ. The auto-zero signal XAZ is a signal to instruct initialization, and for example, transitions from high level to low level each time an event detection signal to be described later is output from the pixel 30. When the auto-zero signal XAZ goes low, the transistor 08 is turned on, which resets the differential signal Vout to its initial value and discharges the capacitor C1.

The transistor Q10 has its source connected to the reference voltage (ground) node, and a bias voltage Vbdiff is applied to a gate of the transistor Q10. The transistor Q10 adjusts a voltage level of an output node n5 of the differentiating circuit 35 on the basis of a voltage level of the bias voltage Vbdiff.

The transistors Q9 and Q10 function as an inverting circuit in which the connection node n4 adjacent to the gate of the transistor Q9 functions as an input node, and the connection node n5 where the transistor 09 and the transistor Q10 are connected functions as an output node.

As described above, the differentiating circuit 35 detects an amount of change in the pixel voltage Vsf through differentiation. The amount of change in the pixel voltage Vsf indicates an amount of change in the light amount of light incident on the pixel 30. The differentiating circuit 35 provides the differential signal Vout to the quantizer 36 via the output node n5.

The quantizer 36 performs a comparison operation of comparing the differential signal Vout with a threshold voltage. The quantizer 36 detects an event indicating that the absolute value of an amount of change in the light amount of incident light exceeds the threshold voltage on the basis of the result of the comparison operation, and outputs an event detection signal COMP+ and an event detection signal COMP−. The quantizer 36 includes transistors Q11 to Q14 and an inverter K1. As the transistors Q11 and Q13, for example, PMOS transistors are used. Furthermore, as the transistors Q12 and Q14, for example, NMOS transistors are used.

The transistors Q11 and Q12 are cascode-connected between the power supply voltage node and the reference voltage (ground) node. The transistor Q11 has its source connected to the power supply voltage node. The transistor Q11 has its drain connected to the inverter K1 and a drain of the transistor Q12. The transistor Q12 has its source connected to the reference voltage (ground) node. The differential signal Vout of the differentiating circuit 35 is applied to a gate of the transistor Q11. Note that a threshold voltage Vhigh is applied to a gate of the transistor Q12.

The transistors Q11 and Q12 compare the differential signal Vout with the threshold voltage Vhigh. Specifically, the transistor Q11 is turned on when the differential signal Vout of the differentiating circuit 35 is lower than the threshold voltage Vhigh, and the event detection signal COMP+output from the drain of the transistor Q11 via the inverter K1 goes low.

The transistors Q13 and Q14 are cascode-connected between the power supply voltage node and the reference voltage (ground) node. The transistor Q13 has its source connected to the power supply voltage node. The transistor Q13 has its drain connected to an output node of the quantizer 36 and a drain of the transistor Q14. The differential signal Vout of the differentiating circuit 35 is applied to a gate of the transistor Q13. Note that a threshold voltage Vlow is applied to a gate of the transistor Q14.

The transistors Q13 and Q14 compare the differential signal Vout with the threshold voltage Vlow. Specifically, the transistor Q13 is turned on when the differential signal Vout of the differentiating circuit 35 is higher than the threshold voltage Vlow, and the event detection signal COMP-output from the drain of the transistor Q13 goes low.

The pixel 30 can detect increases and decreases in the light amount of incident light as events. When the light amount of light incident on the pixel 30 increases, photocharges are generated by the photoelectric conversion element 31, and the voltage at the input node n1 connected to the cathode of the photoelectric conversion element 31 decreases. The decrease in the voltage of the input node n1 causes a decrease in the output voltage Vlog of the charge-to-voltage conversion unit 33 and also causes a decrease in the pixel voltage Vsf of the buffer 34. The differential signal Vout output from the differentiating circuit 35 decreases according to the decrease in the pixel voltage Vsf, and when the differential signal Vout falls below the threshold voltage Vhigh, the low-level event detection signal COMP+ is output. That is, the low-level event detection signal COMP+ indicates that the increase in the light amount of incident light exceeds the threshold determined by the threshold voltage Vhigh.

Similarly, when the light amount of light incident on the pixel 30 decreases, the differential signal Vout output from the differentiating circuit 35 increases, and when the differential signal Vout exceeds the threshold voltage Vlow, the low-level event detection signal COMP− is output. That is, the low-level event detection signal COMP-indicates that the decrease in the light amount of incident light falls below the threshold determined by the threshold voltage Vlow.

Herein, the detection of either the low-level event detection signal COMP+ or the low-level event detection signal COMP− is referred to as event detection. Furthermore, the event has polarity information indicating positive or negative luminance of incident light. The detection of the low-level event detection signal COMP+indicates the positive polarity, and the detection of the low-level event detection signal COMP− indicates the negative polarity.

The pixel 30 need not detect both the event detection signal COMP+and the event detection signal COMP−, and may detect either one. FIG. 3B is a circuit diagram illustrating a second example of the pixel 30. A quantizer 36a in a pixel circuit 32a illustrated in FIG. 3B is different from the quantizer 36 in FIG. 3A in that the transistors Q13 and Q14 are not provided. Therefore, a pixel 30a (and the pixel circuit 32a) in FIG. 3B detects only the increase in the light amount of incident light of the photoelectric conversion element 31, and outputs the event detection signal COMP+.

Similarly, the pixel 30 may have a configuration where the transistors Q11 and Q12 and the inverter K1 are removed from the quantizer 36 in FIG. 3A. In this case, the pixel 30 detects only the decrease in the amount of received light of the photoelectric conversion element 31, and outputs the event detection signal COMP-.

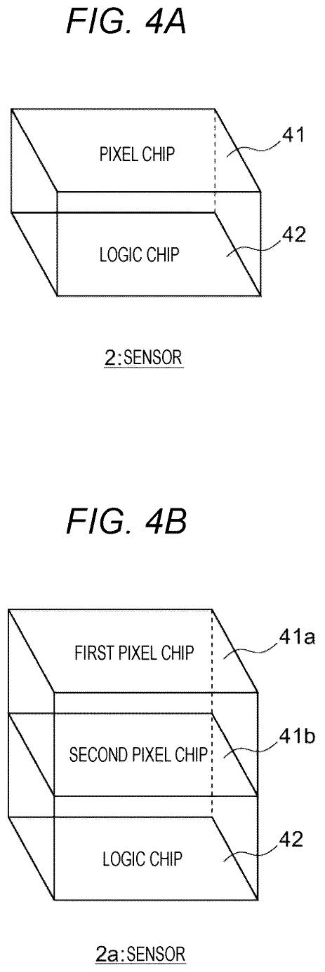

The sensor 2 can also be configured, for example, as a two-tier stacked chip. FIG. 4A is a diagram illustrating a first example of the stacked structure of the sensor 2. The sensor 2 includes a pixel chip 41 and a logic chip 42 stacked on the pixel chip 41. These chips are bonded together using vias or the like. Note that the chips may be bonded together using not only vias but also Cu—Cu bonding or bumps.

In the pixel chip 41, for example, the photoelectric conversion element 31 and a part of the pixel circuit 32 (for example, the transfer transistor TRG and the charge-to-voltage conversion unit 33) are arranged. In the logic chip 42, for example, the remaining part (for example, the buffer 34, the differentiating circuit 35, and the quantizer 36) of the pixel circuit 32, the vertical drive unit 22, and the signal processing unit 23 are arranged.

The sensor 2 may also be configured as a three or more tier stacked chip. FIG. 4B is a diagram illustrating a second example of the stacked structure of the sensor 2. A sensor 2a in FIG. 4B includes a stack of a first pixel chip 41a and a second pixel chip 41b instead of the pixel chip 41. In the first pixel chip 41a, for example, the photoelectric conversion element 31 and the transfer transistor TRG are arranged. In the second pixel chip 41b, for example, the charge-to-voltage conversion unit 33 is arranged.

The sensor 2a in FIG. 4B has a configuration where the charge-to-voltage conversion unit 33 is removed from the first pixel chip 41a and is arranged in the second pixel chip 41b. This configuration allows, even in a case of chip area reduction, the area of the photoelectric conversion element 31 to be secured in the first pixel chip 41a, and the area of the charge-to-voltage conversion unit 33 to be secured in the second pixel chip 41b.

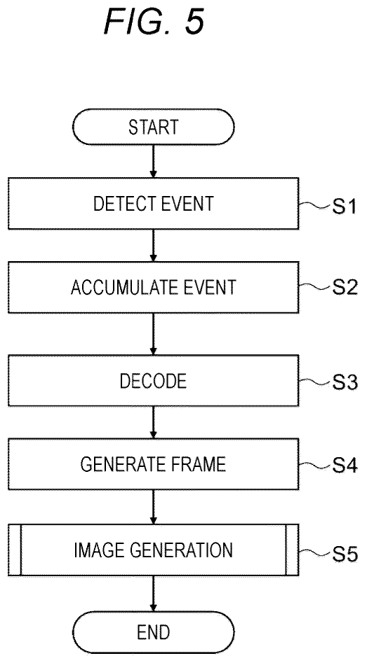

The information processing device 1 according to the present embodiment generates a frame image that visualizes the detection time and detection frequency of an event. The series of processes for such visualization is referred to as event visualization. FIG. 5 is a flowchart illustrating the outline of processing procedure for the event visualization in the information processing device 1. First, each pixel 30 in the sensor 2 detects an event (step S1). The event acquisition unit 11 in the event processing unit 3 acquires compressed event information at intervals of the predetermined period. Herein, the event information acquired within the predetermined period may be referred to as data chunk. The data chunk acquired by the event acquisition unit 11 may be temporarily accumulated in the event accumulation unit 14 (step S2).

The decoding unit 12 decodes the data chunk accumulated in the event accumulation unit 14 and outputs event data (step S3).

The event data output by the decoding unit 12 includes, for example, the following information:
x: X address indicating the detection position (for example, pixel position) of the event,
y: Y address indicating the detection position (for example, pixel position) of the event,
t: time information (timestamp) indicating the detection time of the event, and
p: the polarity information of the event.

The frame generation unit 13 performs frame generation processing of generating frame data on the basis of the event data output from the decoding unit 12 (step S4). The image generation unit 15 performs processing of generating a frame image on the basis of the frame data provided from the frame generation unit 13 (step S5). Details of the image generation processing will be described later.

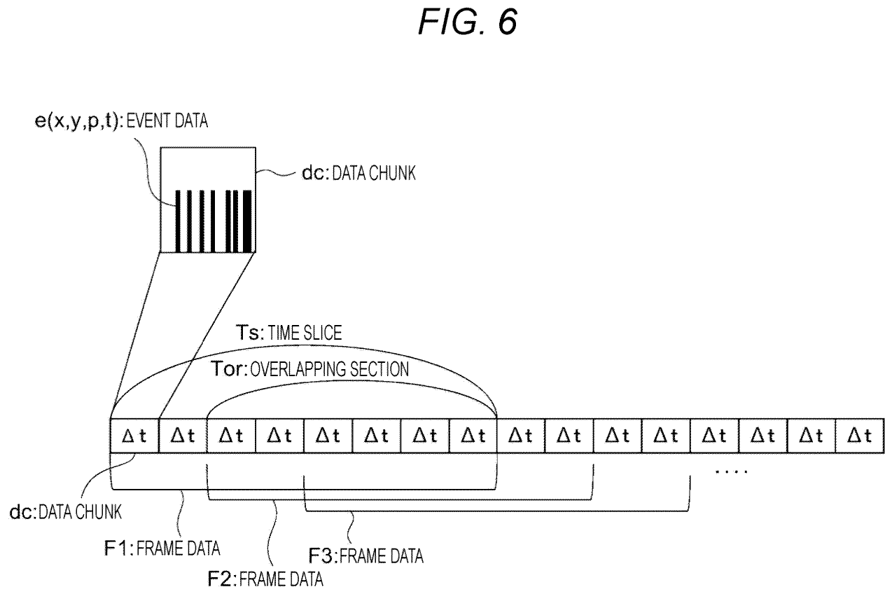

FIG. 6 is a diagram for describing the frame generation processing. The decoding unit 12 outputs event data resulting from decoding each piece of data chunk dc. One piece of data chunk dc includes, for example, event information for all the pixels regarding events occurred within a predetermined unit detection period At. The event information regarding each event is represented by event data e(x, y, p, t) including the event detection positions x and y, the event detection time t, and the event polarity information p.

The frame generation unit 13 outputs a plurality of pieces of event data that falls within a predetermined time slice Ts including a plurality of unit detection periods At as one piece of frame data. In the example in FIG. 6, the time slice Ts has a time width of 8Δt. Furthermore, frame data F1 includes eight data chunks dc. That is, the frame generation unit 13 generates frame data including event information regarding events occurred within the predetermined period (time slice Ts) on a frame-by-frame basis, each frame including the plurality of pixels 30.

The frame generation unit 13 generates frame data including event data in an overlapping time range where two pieces of frame data adjacent to each other along the time axis overlap. Herein, the overlapping time range may be referred to as overlapping section. It is possible to improve, by providing the overlapping section, the accuracy of object tracking.

In the example in FIG. 6, an overlapping section with a time width of 6Δt is provided between the frame data F1 and frame data F2. An overlapping section with a time width of 6Δt is provided between the frame data F2 and frame data F3.

The time width of the time slice Ts and the time width of the overlapping section Tor are not limited to the time widths illustrated in FIG. 6, and any time width may be set. In a case where the time slice Ts is too short, the number of events included in one frame data decreases, which makes it difficult to visually grasp the characteristics of the event information. In a case where the time slice Ts is too long compared to the overlapping section Tor, the intervals for the frame data generation become longer, and the advantage of EVS's high-speed performance is lost. It is therefore desirable to adjust the time width of the time slice Ts and the time width of the overlapping section Tor according to event occurrence conditions.

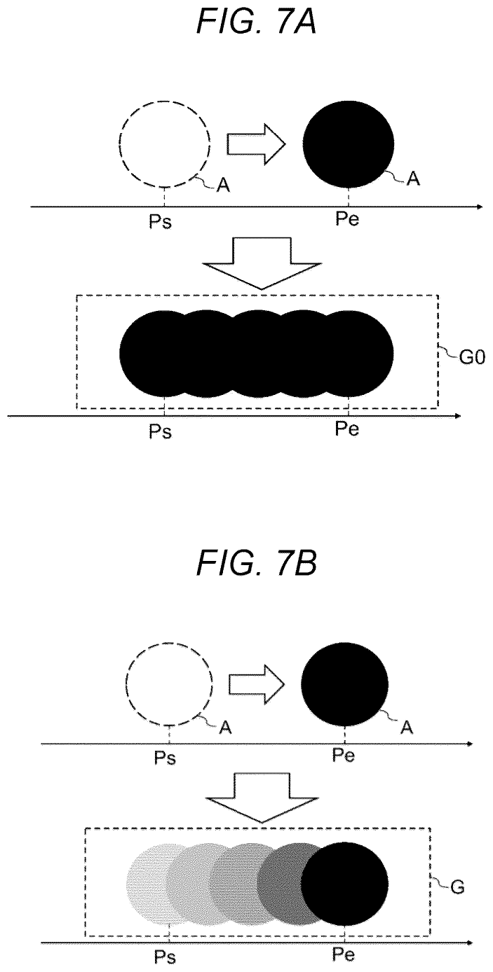

FIG. 7A is a diagram illustrating image generation processing according to a comparative example. FIG. 7A illustrates an example where a subject A moves from a position Ps to a position Pe during the time slice Ts. Luminance changes while the subject A moves from the position Ps to the position Pe, and the sensor 2 detects an event. As a result, image data GO including event data is generated.

The image data GO includes event information regarding events occurred within the time slice Ts, but the occurrence time of each event is unknown. It is therefore not possible to determine from the image data G0 whether the object A moves from the position Ps to the position Pe or from the position Pe to the position Ps.

As illustrated in FIG. 7A, since the image data G0 of the comparative example does not include the information regarding the occurrence time of each event, the motion of the subject cannot be visually interpreted or analyzed. The information processing device 1 of the present disclosure can solve this problem.

FIG. 7B is a diagram illustrating image generation processing according to the present disclosure. FIG. 7B illustrates an example where the subject A moves from the position Ps to the position Pe during the time slice Ts. Image data G output from the information processing device 1 of the present disclosure has a characteristic of changing grayscale according to the occurrence time of each event. Specifically, new events are represented in dark colors, and old events are represented in light colors. This makes it possible to determine the movement of the object A from the position Ps to the position Pe on the basis of changes in grayscale of the image data G. As described above, the information processing device 1 of the present disclosure can output the image data G that enables visual interpretation or analysis of the motion of a subject.

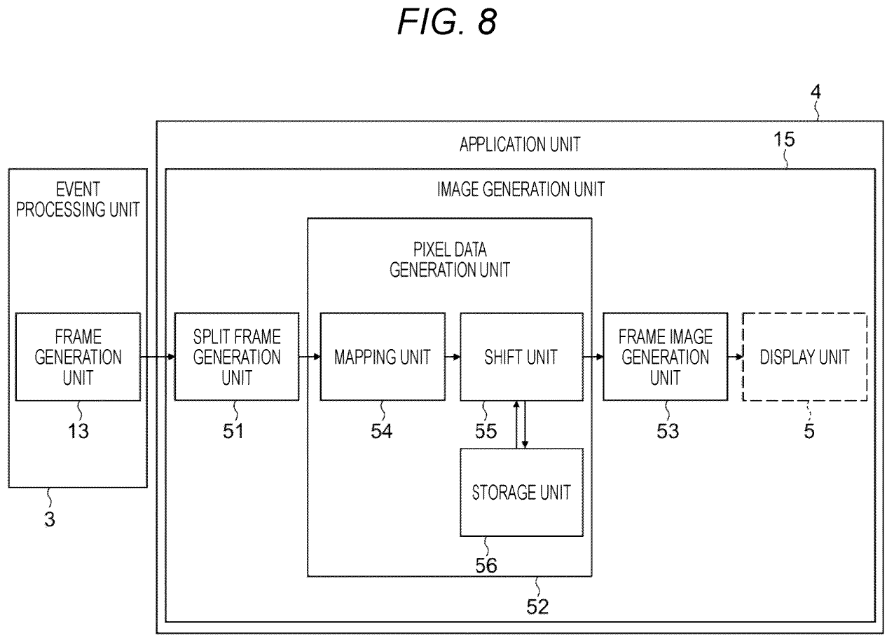

FIG. 8 is a block diagram illustrating a detailed configuration of the image generation unit 15 according to the first embodiment of the present disclosure. As described above, frame data is provided from the frame generation unit 13 to the image generation unit 15. Furthermore, the image generation unit 15 generates image data on the basis of the frame data, and outputs the image data to the display unit 5, for example. The image generation unit 15 includes a split frame generation unit 51, a pixel data generation unit 52, and a frame image generation unit 53.

The split frame generation unit 51 splits the frame data provided from the frame generation unit 13 into a plurality of pieces of section data (split frame data), each having a predetermined time width (hereinafter, referred to as unit period), and output the plurality of pieces of section data to the pixel data generation unit 52.

The pixel data generation unit 52 generates pixel data including event information regarding events detected in each of the plurality of unit periods. The pixel data is generated by the pixel data generation unit 52 for each pixel 30 in the pixel array unit 21, that is, for each individual pixel 30 constituting the frame image. The pixel data generation unit 52 includes a mapping unit 54, a shift unit 55, and a storage unit 56.

The mapping unit 54 associates pixel position information of the event data included in section data D with the corresponding coordinates (hereinafter, referred to as pixel coordinates) on a rendering canvas. The mapping unit 54 acquires the section data from the split frame generation unit 51 and extracts the event data from the section data. The mapping unit 54 allocates the event data to the pixel coordinates on the basis of the pixel position information of the event data. The mapping unit 54 determines whether or not an event corresponding to each pixel exists.

The shift unit 55 acquires the event data for each pixel coordinate from the mapping unit 54, and generates pixel data in binary data format with a plurality of bits for each pixel coordinate. The storage unit 56 arranges and stores, for each pixel coordinate, the pixel data in binary data format with a number of bits equal to the number of pieces of section data obtained by splitting the frame data in pixel order.

The shift unit 55 reads the pixel data from the storage unit 56, bit-shifts the pixel data to the LSB side to discard old binary data on the LSB side, and adds new binary data to the MSB side. The detailed operation of the shift unit 55 will be described later.

The shift unit 55 repeats the shift operation on the pixel data on the basis of the event data of each piece of section data constituting the frame data. After the end of the series of shift operations, the pixel data generation unit 52 outputs the pixel data to the frame image generation unit 53. The frame image generation unit 53 generates, on a frame-by-frame basis, image data (frame image) on the basis of the pixel data of each pixel coordinate.

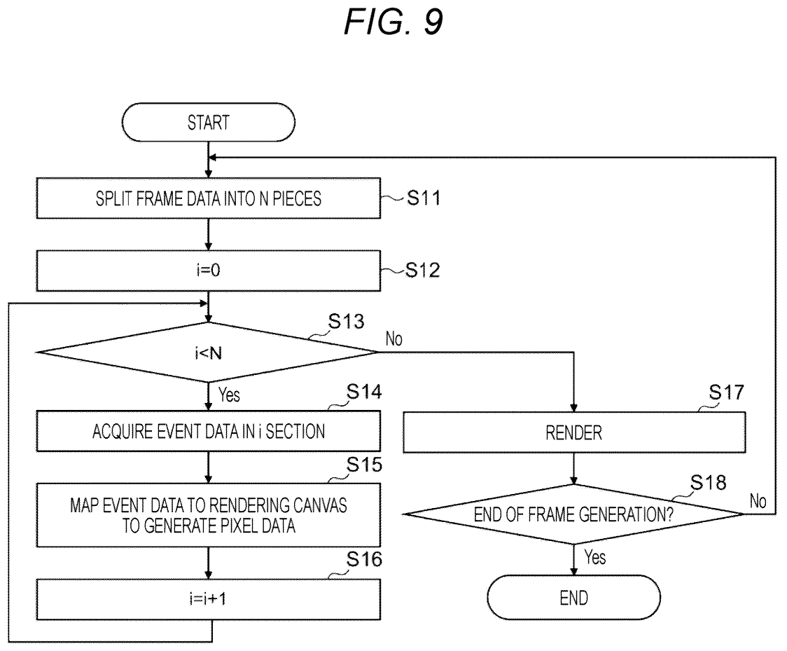

Note that the image generation unit 15 according to the first embodiment of the present disclosure is not limited to the configuration illustrated in FIG. 8 as long as the image generation processing illustrated in FIG. 9 can be performed.

FIG. 9 is a flowchart of image generation according to the first embodiment of the present disclosure. The processing illustrated in FIG. 9 corresponds to the image generation processing in step S5 illustrated in FIG. 5.

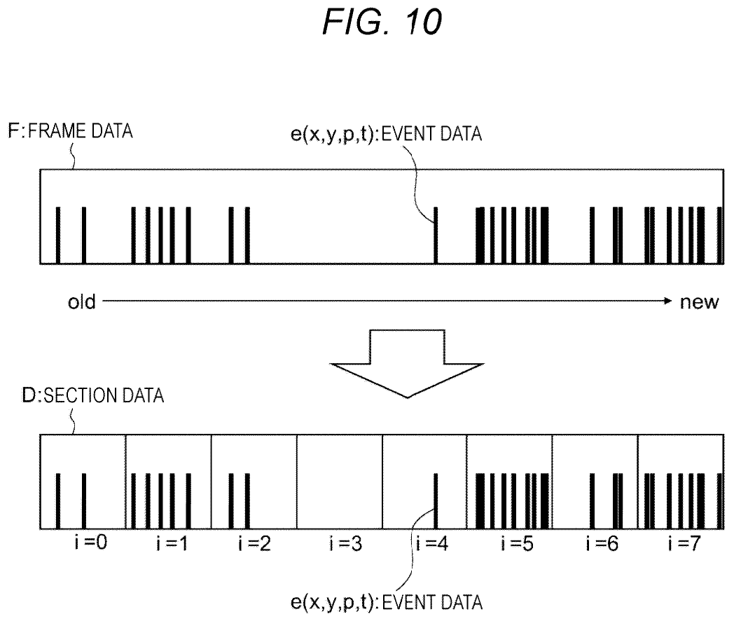

The split frame generation unit 51 splits the frame data into N pieces of section data (step S11). Here, N is a number corresponding to the number of grayscale levels. FIG. 10 is a schematic diagram illustrating how the frame data is split according to the first embodiment of the present disclosure. As illustrated in FIG. 10, the split frame generation unit 51 splits frame data F along the time axis into a plurality of pieces of section data D. That is, the split frame generation unit 51 splits the frame data into a plurality of pieces of unit-period data.

FIG. 10 illustrates an example where the frame data F is split into eight pieces of section data D (N=8).

Furthermore, the unit periods of the eight pieces of section data D all have the same time width. In the following description, this example will be used.

The frame data F includes a plurality of pieces of event data e(x, y, p, t) as described above. These pieces of event data are each allocated to a corresponding one of the pieces of section data D.

Each piece of section data D is assigned an identification number i. The identification number i is assigned a number ranging from 0 to N−1 in chronological order. The pieces of section data D in FIG. 9 are assigned the numbers 0, 1, 2 . . . 7 in chronological order.

Furthermore, the frame data F may be split into time widths the same as the data chunk dc in FIG. 6. In this case, the data chunks dc included in the overlapping section Tor can be reused when the next frame data F is acquired. This will be described later in detail.

Returning to FIG. 9, the description will be continued. Subsequently, the identification number i is set to 0 for initialization (step S12). The processing in steps S13 to S16 is for one piece of section data D. In steps S13 to S16, the eight pieces of section data D are sequentially processed in chronological order while incrementing the identification number i. In step S13, it is determined whether or not the identification number i is smaller than the number of sections N. In a case where the identification number i is smaller than the number of sections N, the processing in and after step S14 is performed.

The pixel data generation unit 52 acquires all the pieces of event data included in the section data D with the identification number i (step S14). One piece of section data D may include a plurality of pieces of event data for a plurality of events.

The pixel data generation unit 52 maps each piece of event data acquired in step S14 to a rendering canvas for image data to generate pixel data (step S15). The rendering canvas refers to a data area where pixel data for each pixel 30 is arranged in the order of the pixels 30, and is provided corresponding to, for example, the storage area of the storage unit 56. The frame image is generated on the basis of each piece of pixel data mapped to the rendering canvas.

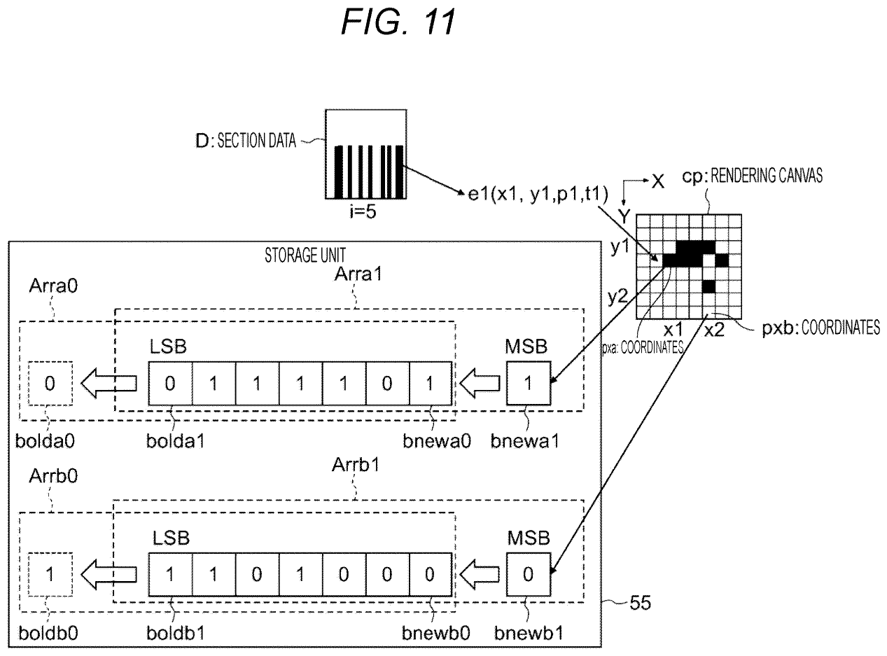

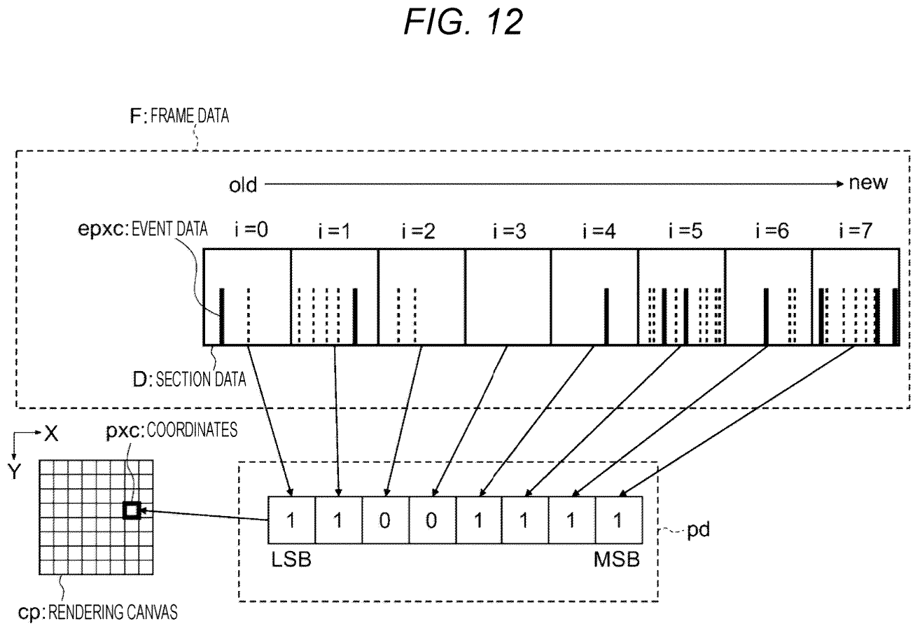

FIG. 11 is a diagram illustrating how the pixel data is generated. With reference to FIG. 11, an example where the pixel data is generated on the basis of the section data D with the identification number i=5 will be described. The mapping unit 54 in the pixel data generation unit 52 extracts an event detection position (x1, y1) from, for example, event data e1(x1, y1, p1, t1) in the section data D. On the basis of this, the event data e1 is allocated to the corresponding coordinates pxa (x1, y1) on a rendering canvas cp.

Similarly, the event data for another event in the section data D is allocated to the corresponding coordinates of the rendering canvas cp. Furthermore, for a pixel where no event exists in the section data D, data indicating that no event data exists is allocated to the corresponding coordinates pxb(x2, y2) on the rendering canvas cp.

The pixel data generation unit 52 determines whether or not there is a corresponding event in the section data D for each coordinate in the rendering canvas cp, and generates binary data of one or more bits (in the example in FIG. 11, one bit). The binary data is, for example, data represented in a binary numeral system with one or more bits, indicating the presence or absence of an event and its polarity. Herein, an example where the binary data is one-bit binary data indicating the presence or absence of an event will be mainly described. The pixel data generation unit 52 generates binary data bnewa1 (for example, 1) indicating that an event exists for the coordinates pxa, and generates binary data bnewb1 (for example, 0) indicating that no event exists for the coordinates pxb. Similarly, the pixel data generation unit 52 further generates binary data for each of the other coordinates in the rendering canvas cp on the basis of the presence or absence of the corresponding event in the section data D.

The storage unit 56 stores pixel data corresponding to each coordinate in the rendering canvas cp, for example, as bit-string data. For example, it is assumed that the storage unit 56 stores pixel data Arra0 corresponding to the coordinates pxa before mapping. The pixel data Arra0 has binary data bolda0 in the least significant bit (LSB) and binary data bnewa0 in the most significant bit (MSB).

The storage unit 56 stores, for example, N-bit pixel data for each coordinate on the rendering canvas cp. In the example in FIG. 11, N=8.

The shift unit 55 shifts each bit of the pixel data Arra0 to the LSB side by one bit to generate pixel data Arra1. As a result, the LSB of the pixel data Arra0 is discarded. Furthermore, the shift unit 55 adds the corresponding event data bnewa1 in the section data D to the MSB. As a result, the new pixel data Arra1 having binary data bolda1 in the LSB and the binary data bnewa1 in the MSB is generated. The binary data bnewa1 has a bit value of 1, indicating that an event exists.

Furthermore, it is assumed that the storage unit 56 stores pixel data Arrb0 having binary data boldb0 in the LSB and binary data bnewb0 in the MSB, corresponding to the coordinates pxb, before mapping. The shift unit 55 discards the binary data boldb0 from the LSB of the pixel data Arrb0, shifts the binary data ranging from binary data boldb1 to the binary data bnewb0 to the LSB side by one bit, and adds the binary data bnewb1 to the MSB side. The binary data bnewb1 is 0, indicating that no event exists. As a result, pixel data Arrb1 is generated.

Note that the pieces of pixel data Arra0 and Arrb0 stored in the storage unit 56 are pixel data generated immediately before. Specifically, immediately before the processing in step S15 is performed on the section data D with the identification number i=5, pixel data generated as a result of the processing on the section data D with the identification number i=4 is stored in the storage unit 56.

As described above, the shift unit 55 shifts each bit of the pixel data stored for each coordinate on the rendering canvas cp in the storage unit 56 to the LSB side by one bit, and adds one-bit information indicating the presence or absence of an event in the section data D to the MSB, thereby generating the pixel data of each pixel 30 for each piece of section data D.

Upon completion of the processing in step S15 in FIG. 9, the identification number i of the section data D is incremented (step S16), and the processing in and after step S13 is repeated. In step S13, in a case where the identification number i is smaller than the number of sections N, the processing in steps S14 to S15 is performed on the next section data D. As described above, the pixel data generation processing is performed on all the pieces of section data D of the frame data F. The pixel data generation unit 52 outputs the new pixel data generated in step S15 to the frame image generation unit 53.

FIG. 12 is a diagram illustrating a correspondence between frame data and pixel data according to the first embodiment of the present disclosure. The frame data F includes event data corresponding to all the pixels 30 in the pixel array unit 21. Each piece of event data in the frame data F is allocated to each coordinate in the rendering canvas cp. In FIG. 12, event data of a specific pixel in the frame data F is represented by a thick line, and event data of the other pixels is represented by a dashed line. Furthermore, FIG. 12 illustrates an example where the event data of the specific pixel in the frame data F is allocated to pixel data pd of coordinates pxc in the rendering canvas cp.

The pixel data generation unit 52 associates each bit of the pixel data pd with a different piece of section data D in the frame data F, and generates a corresponding bit value of the pixel data pd on the basis of event information of the corresponding pixel 30 in the section data D. FIG. 12 illustrates an example where a corresponding bit value of the pixel data pd is generated on the basis of event data epxc of the specific pixel.

As illustrated in FIG. 11, the pixel data pd has older binary data on the LSB side and has newer binary data on the MSB side. In particular, in a case where the length of the pixel data pd is equal to the number of pieces of section data, the LSB of the pixel data pd corresponds to the section data D with the identification number i=0, and the MSB corresponds to the section data D with the identification number i=N−1 (i=7 in the case of FIG. 12). That is, the pixel data generation unit 52 generates bit values of the higher-order bits of the pixel data pd on the basis of the event information of the corresponding pixel 30 in newer section data D.

The binary data of each bit of the pixel data pd is set to, for example, 1 in a case where the event data (in FIG. 12, event data epxc) of the corresponding pixel 30 exists in the corresponding section data D, and is set to, for example, 0 in a case where the event data epxc does not exist. FIG. 12 illustrates an example where, in a case where at least one piece of event data epxc exists in the corresponding section data D, 1 is set, but the condition for setting the binary data of each bit of the pixel data to 1 may be determined as desired. For example, the binary data of each bit of the pixel data may be set to 1 in a case where the number of events of the corresponding pixel 30 in the corresponding section data D is greater than or equal to a predetermined threshold, and, otherwise, may be set to 0.

As illustrated in FIG. 12, the pixel data generation unit 52 generates the pixel data pd including the event information detected in each of the plurality of unit periods. The pixel data pd is bit-string data of a plurality of bits. In the pixel data pd, unit-period event information is arranged in chronological order from the MSB side to the LSB side of the bit-string data. Furthermore, the event information is represented by one or more bits for each unit period. Note that the pixel data pd may include the event polarity information p for each unit period.

The pixel data generation unit 52 generates pixel data for the other coordinates in the rendering canvas cp in a similar manner. That is, the pixel data generation unit 52 generates pixel data for each of all the pixels 30 in the pixel array unit 21 on the basis of the event information of the corresponding pixel 30 included in each of the plurality of pieces of section data D.

Returning to FIG. 9, the description will be continued. The frame image generation unit 53 renders a frame image on the basis of the pixel data of each pixel for one frame generated as a result of the processing in steps S13 to S16 (step S17). Herein, the pixel data of each pixel constituting the frame image is collectively referred to as image data.

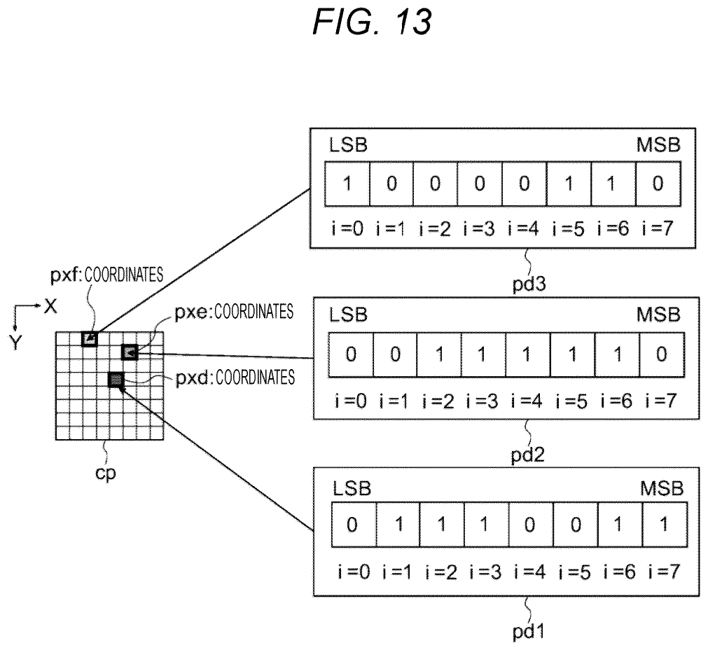

FIG. 13 is a diagram illustrating an example of the image data according to the first embodiment of the present disclosure. FIG. 13 illustrates three pieces of pixel data pdl, pd2, and pd3 that are a part of the image data. These three pieces of pixel data correspond to coordinates pxd, pxe, and pxf in the rendering canvas cp.

The pixel data pd1 in FIG. 13 has the MSB set to 1, indicating an event has occurred most recently. The pixel data pd2 has more bits set to 1 than the pixel data pd3, indicating a higher frequency of events. The pixel values of the pixel data pd1, pd2, and pd3 are 206, 124, and 97, respectively. Therefore, the pixel data pd1 has the highest grayscale (luminance), the pixel data pd2 has the second highest grayscale (luminance), and the pixel data pd3 has the lowest grayscale (luminance).

As described above, for the pixel data, the more recent the event occurrence (detection), the higher the pixel value, and the higher the event occurrence (detection) frequency, the higher the pixel count. It is therefore possible to grasp, on the basis of the grayscale (luminance) of each pixel of the frame image generated by the frame image generation unit 53, the occurrence (detection) time and occurrence (detection) frequency of the frame.

The number of grayscale levels represented by each pixel value of the pixel data pd1, pd2, and pd3 corresponds to the number of sections N of the frame data F and corresponds to the number of the plurality of unit periods.

The frame image generation unit 53 may reflect the polarity information p of each event in the image data. For example, for either the positive polarity event or the negative polarity event, the occurrence time and occurrence frequency of the event may be represented using grayscale. Furthermore, for the other, the occurrence time and occurrence frequency of the event may be represented using the grayscale of one of the RGB colors.

After the end of the frame image rendering processing in step S17 in FIG. 9, it is determined whether or not to terminate the frame generation processing (step S18). Terminating the frame generation processing refers to not rendering a new frame image. In a case where the frame generation processing is terminated, the processing in FIG. 9 is terminated.

In a case where it is determined that the frame generation processing continues in step S18, the processing in and after step S11 is repeated to render a new frame image.

As illustrated in FIG. 6, the frame generation unit 13 generates each frame data including the overlapping time range where two pieces of frame data adjacent to each other along the time axis overlap. Although FIG. 6 illustrates an example where each frame data is split into the plurality of data chunks dc at equal intervals, the split frame generation unit 51 generates a plurality of pieces of section data resulting from splitting each frame data generated by the frame generation unit 13 into unit periods. As described above, the pixel data is generated on the basis of the frame data including the plurality of pieces of split section data.

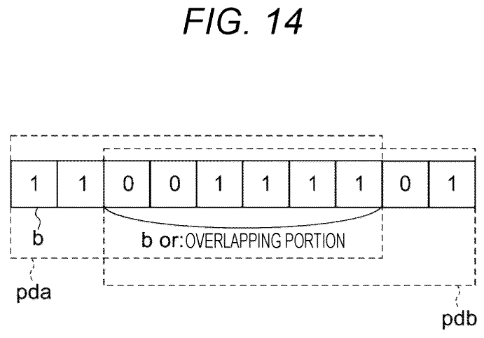

FIG. 14 is a diagram illustrating two pieces of pixel data generated on the basis of two pieces of frame data adjacent to each other along the time axis. Two pieces of frame data adjacent to each other along the time axis that are provided to the split frame generation unit 51 include an overlapping portion where the two pieces of frame data overlap, and the time width of the overlapping portion is the same as the time width of the overlapping section in FIG. 6, for example. Two pieces of pixel data pda and pdb generated on the basis of the two pieces of frame data adjacent to each other along the time axis also include an overlapping portion bor as illustrated in FIG. 14. The time width of the overlapping portion bor is the same as the time width of the overlapping section Tor and is an integral multiple of the unit period, which is the time width of section data. The number of unit periods of the overlapping portion does not necessarily coincide with the number of data chunks of the overlapping section Tor.

As illustrated in FIG. 14, it is possible to accurately grasp how an event changes by providing the overlapping portion in two pieces of pixel data adjacent to each other along the time axis. For example, the direction in which a moving object travels can be represented as a trajectory in the frame image. Furthermore, when new pixel data is generated, the binary data of the overlapping portion overlapping with previously generated pixel data can be used as valid data as it is, so that the new pixel data can be quickly generated, allowing an increase in the frame rate.

Furthermore, in the above-described case, the frame image generation unit 53 generates image data such that two frame images that have a grayscale corresponding to the event detection time and detection frequency for each pixel 30 and are adjacent to each other along the time axis include event information within the overlapping time range.

As described above, since the information processing device 1 according to the first embodiment of the present disclosure generates pixel data having a pixel value corresponding to the event detection time and detection frequency, it is possible to generate a frame image that facilitates the visual recognition of not only the event occurrence location but also the event occurrence time and occurrence frequency. More specifically, in the frame image according to the present embodiment, the event occurrence direction and occurrence time can be represented by, for example, luminance or grayscale, so that it becomes easier to visually grasp when and in which direction the moving object has traveled. Furthermore, it is possible to visually grasp the event occurrence time and duration.

As described above, in the image generation processing of the present disclosure described with reference to FIG. 9, the event occurrence time is represented in a manner that simulates the afterimage effect occurring in human eyes. This allows the information processing device 1 of the present disclosure to visualize events in a form that is easier for humans to understand than before. Furthermore, in the image generation processing of the present disclosure, even in a case where a plurality of events occurs at the same pixel position and within one time slice, it is possible to identify each of the events using grayscale or luminance.

### Second Embodiment

Although the split frame generation unit 51 according to the first embodiment splits the frame data F into the plurality of pieces of section data D with the same time width, the time widths of the plurality of pieces of section data D are not necessarily the same.

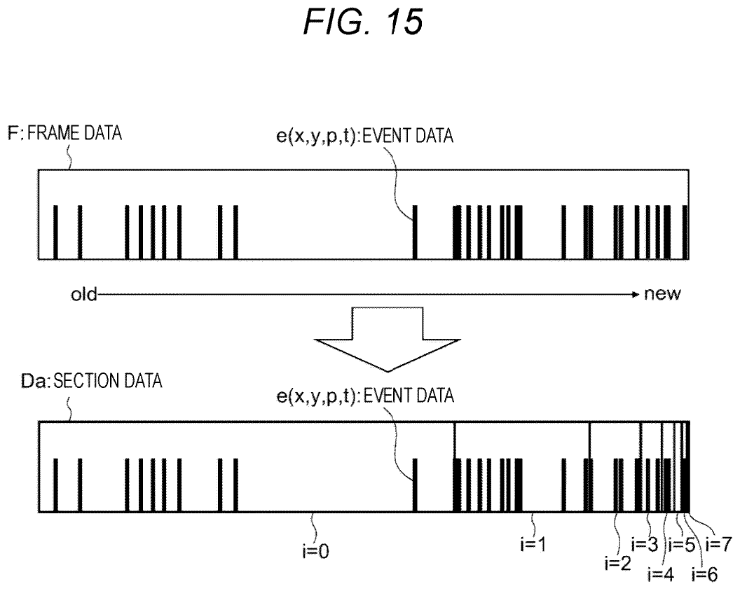

FIG. 15 is a schematic diagram illustrating how frame data is split according to a second embodiment of the present disclosure. A split frame generation unit 51 according to the second embodiment splits the data into a plurality of pieces of section data Da with different time widths in step S11 in FIG. 9. In the second embodiment, for example, it is possible to split a time range where more detailed detection of event occurrence in the frame data F is desired into section data Da with a narrower time width and split the other time range into section data Da with a wider time width.

In the example in FIG. 15, to achieve more detailed detection of event occurrence within a time period closer to the current time, the frame data F is split such that as the time period becomes older, the time width (unit period) of the section data increases logarithmically, and as the time period becomes newer, the time width decreases.

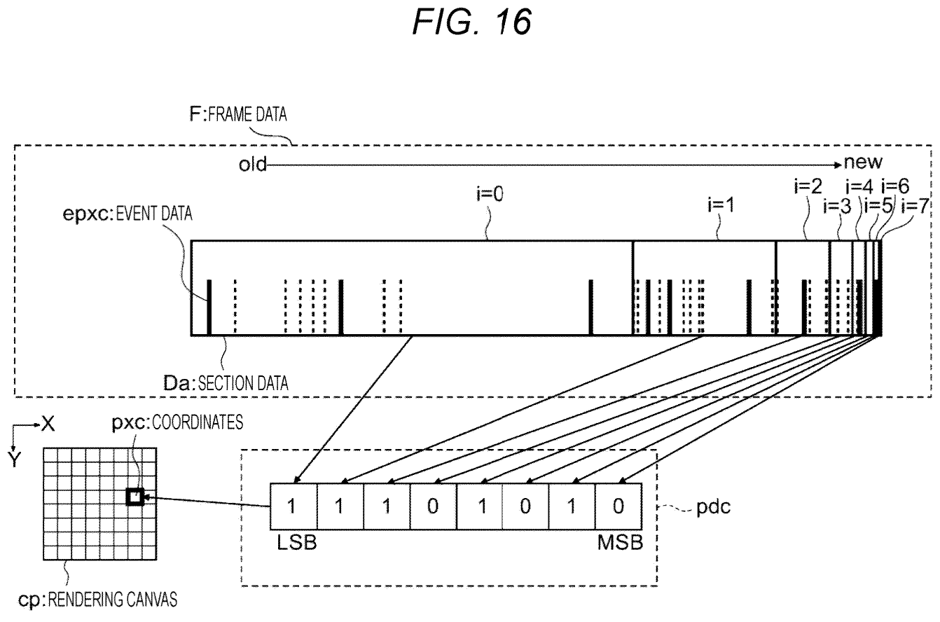

FIG. 16 is a diagram illustrating a correspondence between the frame data F and the pixel data according to the second embodiment of the present disclosure. The frame data F in FIG. 16 includes the same event data as the frame data F illustrated in FIG. 12. However, as described above, the section data Da in FIG. 16 is different from the section data D in FIG. 12 in the time range and time width occupied in the frame data F. Furthermore, the section data Da in FIG. 16 is different from the section data D in FIG. 12 with the same identification number i in the event data included therein. Therefore, the pixel data pdc in FIG. 16 is different from the pixel data pd illustrated in FIG. 12.

The pixel data pdc in FIG. 16 is sensitive in detecting the presence or absence of event data in the new time range compared to the pixel data pd illustrated in FIG. 12. This allows for more detailed tracking of changes in luminance of a subject, particularly in newer time ranges, and more precise identification of event occurrence time.

As described above, in the second embodiment of the present disclosure, since the pieces of section data D resulting from splitting the frame data F have different time widths, it is possible to generate pixel data including more event information occurring at newer times than event information occurring at older times, for example. As a result, in the frame image generated by the information processing device 1 according to the second embodiment, the information regarding the occurrence position, occurrence time, and occurrence frequency of events occurred at newer times can be visually represented in more detail.

### Third Embodiment

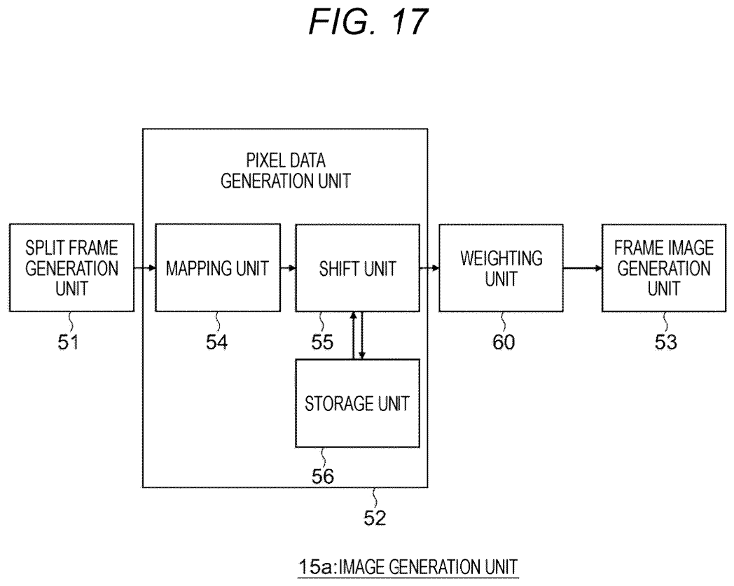

Weighting may be performed on the pixel data output from the pixel data generation unit 52. FIG. 17 is a block diagram illustrating a detailed configuration of an image generation unit 15 according to a third embodiment of the present disclosure. An image generation unit 15a in FIG. 17 has a configuration where a weighting unit 60 is newly added to the image generation unit 15 in FIG. 8. The weighting unit 60 is arranged between the pixel data generation unit 52 and the frame image generation unit 53.

The weighting unit 60 performs predetermined weighting on the pixel data. A specific weighting method may be determined as desired. For example, the bit value of a specific bit of the pixel data may be inverted, or each bit of the pixel data may be shifted to the MSB side or the LSB side. The pixel data weighted by the weighting unit 60 is provided to the frame image generation unit 53.

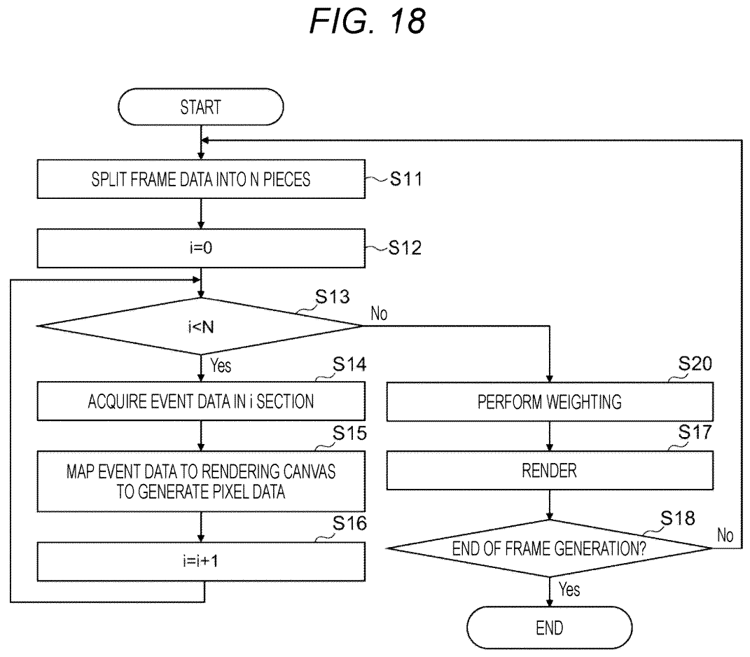

FIG. 18 is a flowchart of image generation according to the third embodiment of the present disclosure. In FIG. 18, weighting processing (step S20) is added between step S13 and step S17. In step S20, the weighting unit 60 performs weighting on the pixel data output from the pixel data generation unit 52. In step S17, the frame image generation unit 53 outputs image data on the basis of the weighted pixel data.

For example, it is possible to represent, by shifting data other than new binary data (for example, the binary data in the MSB) of the pixel data to the LSB side, the new event data in an emphasized manner. Furthermore, it is also possible to change the time range of interest by shifting binary data in a specific time range to the MSB side.

As described above, since the image generation unit 15a according to the third embodiment of the present disclosure performs weighting on the pixel data as necessary, the display form of the event information in the frame image can be varied in various ways in accordance with event characteristics, enabling the provision of high-visibility frame images. Note that the weighting on the pixel data according to the third embodiment can be applied to both the first and second embodiments.

### Fourth Embodiment

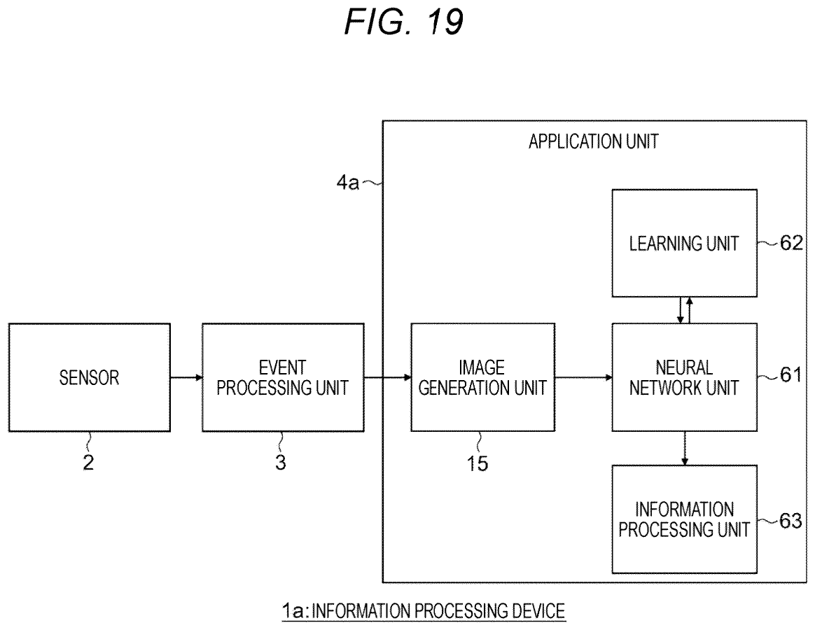

The information processing device 1 of the present disclosure may also have a machine learning function. FIG. 19 is a block diagram illustrating a configuration example of an information processing device 1 according to a fourth embodiment of the present disclosure. An information processing device la illustrated in FIG. 19 includes an application unit 4a. The application unit 4a includes a neural network unit 61, a learning unit 62, and an information processing unit 63.

The image generation unit 15 (or the image generation unit 15a) generates image data through the processing in FIG. 9 (or FIG. 18). The neural network unit 61 acquires the image data from the image generation unit 15 and stores the image data.

The learning unit 62 performs learning processing of updating weights of a neural network used for predetermined information processing on the basis of the image data stored in the neural network unit 61 to generate a trained predetermined information processing model. The predetermined information processing includes at least one of object tracking, object recognition, or prediction of object motion.

The information processing unit 63 inputs the image data generated by the image generation unit 15 into the trained neural network unit 61, and performs the predetermined information processing on the basis of the data output from the trained neural network unit 61.

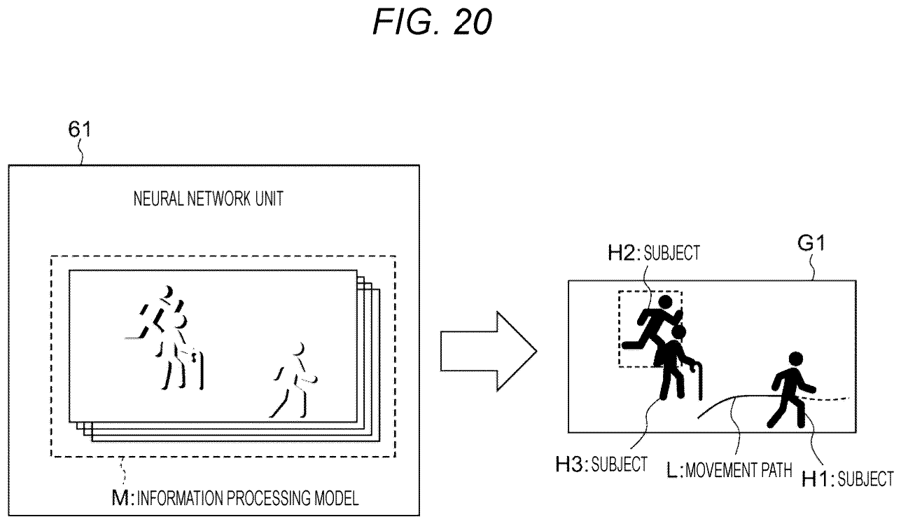

FIG. 20 is a schematic diagram illustrating an example of the information processing performed by the information processing unit 63. In FIG. 20, the neural network unit 61 includes an information processing model M. The information processing unit 63 performs the information processing on the basis of the information processing model M and image data G1 capturing subjects H1, H2, and H3.

The image data of the present disclosure can represent the motion of a subject as described with reference to FIG. 7B. It is possible to identify or predict, by inputting the image data into the information processing model M, a movement path L of the subject H1 in the image data G1, for example. Furthermore, the image data of the present disclosure allows even a plurality of events occurred in the same pixel 30 to be distinguished on the basis of differences in grayscale. It is therefore possible to identify the event of the subject H2 even in a case where the event of the subject H2 and the event of the subject H3 overlap.

As described above, it is possible to output data reflecting the learning outcomes from the neural network by training the weights of the neural network using the image data generated by the information processing device 1 according to the first to third embodiments and inputting new image data into the trained neural network, and perform various types of information processing using the data. It is therefore possible to perform information processing such as object tracking, object recognition, or prediction of object motion using the image data generated by the information processing device 1 according to the first to third embodiments.

### (Application Example)

The technology according to the present disclosure can be applied to various products. For example, the technology according to the present disclosure may also be implemented as a device mounted on any kind of moving object such as an automobile, an electric vehicle, a hybrid electric vehicle, a motorcycle, a bicycle, a personal mobility, an airplane, a drone, a vessel, a robot, a construction machine, or an agricultural machine (tractor).

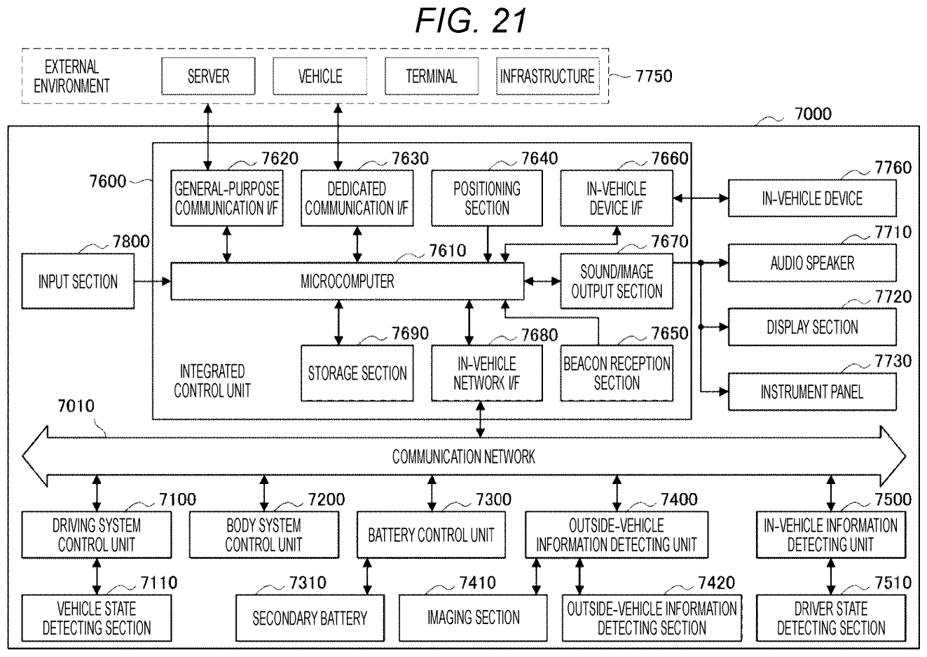

FIG. 21 is a block diagram illustrating a schematic configuration example of a vehicle control system 7000 as an example of a moving object control system to which the technology according to the present disclosure can be applied. The vehicle control system 7000 includes a plurality of electronic control units connected to each other via a communication network 7010. In the example illustrated in FIG. 21, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. In FIG. 21, as a functional configuration of the integrated control unit 7600, a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690 are illustrated. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

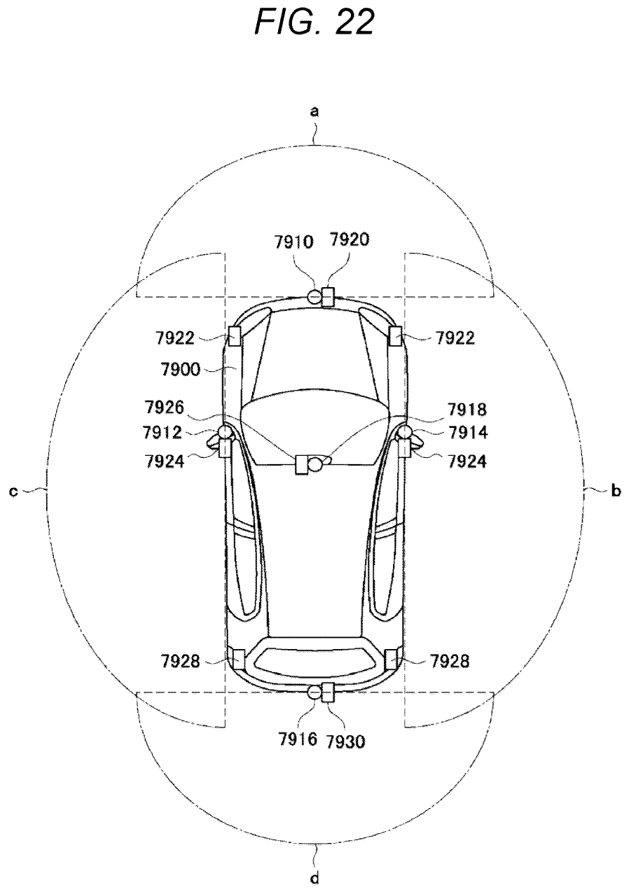

Here, FIG. 22 illustrates an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 22 illustrates an example of an imaging range of each of the imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 21, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark) ), worldwide interoperability for microwave access (WiMAX (registered trademark) ), long term evolution (LTE (registered trademark) ), LTE-advanced (LTE-A), or the like, or another wireless communication protocol such as wireless LAN (referred to also as wireless fidelity (Wi-Fi (registered trademark) ), Bluetooth (registered trademark), or the like. The general-purpose communication I/F 7620 may, for example, connect to an apparatus (for example, an application server control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example in FIG. 21, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Note that in the example illustrated in FIG. 21, at least two control units connected to each other via the communication network 7010 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for implementing the respective functions of the event processing unit 3 and the application unit 4 according to the present embodiment described with reference to FIG. 1 can be implemented in any of the control units or the like. Furthermore, a computer-readable recording medium in which such a computer program is stored can be provided. The recording medium is, for example, a magnetic disk, an optical disc, a magneto-optical disk, a flash memory, or the like. Furthermore, the computer program described above may be distributed via, for example, a network without using a recording medium.

Note that the present technology may have the following configurations.

(1) An information processing device including:
a pixel including a light detection element that detects an event based on an amount of change in a light amount of incident light; and
a pixel data generation unit that generates pixel data including information regarding the event detected in each of a plurality of unit periods.

(2) The information processing device according to (1), in which
the pixel data has a pixel value corresponding to a detection time and detection frequency of the event.

(3) The information processing device according to (2), in which

the pixel data has a larger pixel value as the detection time of the event is more recent and the detection frequency of the event is higher.

(4) The information processing device according to (2) or (3), in which
the pixel data has a grayscale level or luminance corresponding to the number of the plurality of unit periods.

(5) The information processing device according to any one of (1) to (4), in which
the pixel data includes bit-string data of a plurality of bits, and
the information regarding the event in older unit periods is arranged from a higher-order bit side to a lower-order bit side of the bit-string data.

(6) The information processing device according to (5), in which
the information regarding the event is represented by one or more bits for each of the unit periods.

(7) The information processing device according to any one of (1) to (6), in which
the pixel data includes information indicating a polarity of the event for each of the unit periods.

(8) The information processing device according to any one of (1) to (7), in which
the plurality of unit periods has an identical time width.

(9) The information processing device according to any one of (1) to (7), in which
of the plurality of unit periods, an older unit period has a longer time width.

(10) The information processing device according to any one of (1) to (9), further including:
a plurality of the pixels arranged in a one-dimensional array or a two-dimensional matrix;
a frame generation unit that generates frame data including the information regarding the event occurred within a predetermined period on a frame-by-frame basis, each frame including the plurality of pixels; and
a split frame generation unit that generates a plurality of pieces of split frame data by splitting the frame data into a plurality of pieces along a time axis, in which
the pixel data generation unit generates the pixel data for each of the plurality of pixels on the basis of the information regarding the event of a corresponding pixel included in each of the plurality of pieces of split frame data.

(11) The information processing device according to (10), in which
two pieces of the frame data adjacent to each other along the time axis include the information regarding the event occurred within an overlapping time range.

(12) The information processing device according to (11), in which
the overlapping time range has a length that is an

### integral multiple of each of the unit periods.

(13) The information processing device according to any one of (10) to (12), in which
the pixel data generation unit associates each bit of the pixel data with a corresponding one of the pieces of split frame data different from each other, and generates a corresponding bit value of the pixel data on the basis of the information regarding the event of a corresponding pixel in a corresponding piece of the split frame data.

(14) The information processing device according to (13), in which
the pixel data generation unit generates a bit value of a higher-order bit of the pixel data on the basis of the information regarding the event a corresponding pixel in a more recent piece of the split frame data.

(15) The information processing device according to any one of (10) to (14), in which
the split frame generation unit splits the frame data into the plurality of pieces of split frame data of the unit periods having an identical time length.

(16) The information processing device according to any one of (10) to (14), in which
the split frame generation unit splits the frame data into the plurality of pieces of split frame data of the unit periods having different time lengths.

(17) The information processing device according to (16), in which
the split frame generation unit makes the time length of a more recent piece of the split frame data shorter.

(18) The information processing device according to any one of (10) to (17), further including
a frame image generation unit that generates a frame image on the basis of the plurality pieces of pixel data corresponding to the plurality of pixels.

(19) The information processing device according to (18), in which
the frame image generation unit generates the frame image such that two of the frame images, having a grayscale corresponding to a detection time and detection frequency of the event for each of the pixels and adjacent to each other along the time axis, include the information regarding the event within an overlapping time range.

(20) The information processing device according to (18) or (19), further including:
a learning unit that performs learning processing of updating a weight of a neural network used for predetermined information processing, the predetermined information processing including at least one of object tracking, object recognition, or prediction of object motion, on the basis of the frame image; and
an information processing unit that performs the predetermined information processing on the basis of the neural network that has undergone the learning processing and the frame image.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

1, 1a Information processing device
2, 2a Sensor
3 Event processing unit
4, 4a Application unit
5 Display unit
11 Event acquisition unit
12 Decoding unit
13 Frame generation unit
14 Event accumulation unit
15, 15a Image generation unit
21 Pixel array unit
22 Vertical drive unit
23 Signal processing unit
30, 30a Pixel
31 Photoelectric conversion element
32, 32a Pixel circuit
33 Charge-to-voltage conversion unit
34 Buffer
35 Differentiating circuit
36, 36a Quantizer
37 Logarithmic response unit
41 Pixel chip
41a First pixel chip
41b Second pixel chip
42 Logic chip
51 Split frame generation unit
52 Pixel data generation unit
53 Frame image generation unit
54 Mapping unit
55 Shift unit
56 Storage unit
60 Weighting unit
61 Neural network unit
62 Learning unit
63 Information processing unit

1. An information processing device comprising:
a pixel including a light detection element that detects an event based on an amount of change in a light amount of incident light; and
a pixel data generation unit that generates pixel data including information regarding the event detected in each of a plurality of unit periods.

2. The information processing device according to claim 1, wherein
the pixel data has a pixel value corresponding to a detection time and detection frequency of the event.

3. The information processing device according to claim 2, wherein
the pixel data has a larger pixel value as the detection time of the event is more recent and the detection frequency of the event is higher.

4. The information processing device according to claim 2, wherein
the pixel data has a grayscale level or luminance corresponding to the number of the plurality of unit periods.

5. The information processing device according to claim 1, wherein
the pixel data includes bit-string data of a plurality of bits, and
the information regarding the event in older unit periods is arranged from a higher-order bit side to a lower-order bit side of the bit-string data.

6. The information processing device according to claim 5, wherein
the information regarding the event is represented by one or more bits for each of the unit periods.

7. The information processing device according to claim 1, wherein
the pixel data includes information indicating a polarity of the event for each of the unit periods.

8. The information processing device according to claim 1, wherein
the plurality of unit periods has an identical time width.

9. The information processing device according to claim 1, wherein
of the plurality of unit periods, an older unit period has a longer time width.

10. The information processing device according to claim 1, further comprising:
a plurality of the pixels arranged in a one-dimensional array or a two-dimensional matrix;
a frame generation unit that generates frame data including the information regarding the event occurred within a predetermined period on a frame-by-frame basis, each frame including the plurality of pixels; and
a split frame generation unit that generates a plurality of pieces of split frame data by splitting the frame data into a plurality of pieces along a time axis, wherein
the pixel data generation unit generates the pixel data for each of the plurality of pixels on a basis of the information regarding the event of a corresponding pixel included in each of the plurality of pieces of split frame data.

11. The information processing device according to claim 10, wherein
two pieces of the frame data adjacent to each other along the time axis include the information regarding the event occurred within an overlapping time range.

12. The information processing device according to claim 11, wherein
the overlapping time range has a length that is an integral multiple of each of the unit periods.

13. The information processing device according to claim 10, wherein
the pixel data generation unit associates each bit of the pixel data with a corresponding one of the pieces of split frame data different from each other, and generates a corresponding bit value of the pixel data on a basis of the information regarding the event of a corresponding pixel in a corresponding piece of the split frame data.

14. The information processing device according to claim 13, wherein
the pixel data generation unit generates a bit value of a higher-order bit of the pixel data on a basis of the information regarding the event a corresponding pixel in a more recent piece of the split frame data.

15. The information processing device according to claim 10, wherein
the split frame generation unit splits the frame data into the plurality of pieces of split frame data of the unit periods having an identical time length.

16. The information processing device according to claim 10, wherein
the split frame generation unit splits the frame data into the plurality of pieces of split frame data of the unit periods having different time lengths.

17. The information processing device according to claim 16, wherein
the split frame generation unit makes the time length of a more recent piece of the split frame data shorter.

18. The information processing device according to claim 10, further comprising
a frame image generation unit that generates a frame image on a basis of the plurality pieces of pixel data corresponding to the plurality of pixels.

19. The information processing device according to claim 18, wherein
the frame image generation unit generates the frame image such that two of the frame images, having a grayscale corresponding to a detection time and detection frequency of the event for each of the pixels and adjacent to each other along the time axis, include the information regarding the event within an overlapping time range.

20. The information processing device according to claim 18, further comprising:
a learning unit that performs learning processing of updating a weight of a neural network used for predetermined information processing, the predetermined information processing including at least one of object tracking, object recognition, or prediction of object motion, on a basis of the frame image; and
an information processing unit that performs the predetermined information processing on a basis of the neural network that has undergone the learning processing and the frame image.
